(19) United States
(12) Patent Application Publication
(10) Pub. No.: US 2013/0166343 A1
(43) Pub. Date: Jun. 27, 2013

(54) SYSTEMS AND METHODS FOR SCHEDULING A RESOURCE FIELD OF THE INVENTION

(71) Applicants: John Lonergan, Evanston, IL (US); Chris Dejong, Evanston, IL (US); Jessica Dejong, Evanston, IL (US)

(72) Inventors: John Lonergan, Evanston, IL (US); Chris Dejong, Evanston, IL (US); Jessica Dejong, Evanston, IL (US)

(21) Appl. No.: 13/679,799

(22) Filed: Nov. 16, 2012

Related U.S. Application Data
(60) Provisional application No. 61/561,606, filed on Nov. 18, 2011.

(51) Int. Cl. G06Q 10/10

(52) U.S. Cl. CPC G06Q 10/1095
USPC 705/7.19

(57) ABSTRACT

A computer implemented method. A scheduling request is received from a requesting device. The scheduling request comprises a request to reserve a first resource for a first entity and a second resource for a second entity. A database is searched to identify at least one schedule slot during which the first resource can be reserved for the first entity and the second resource can be reserved for the second entity. At least one scheduling slot is sent to the requesting device.

### CROSS-REFERENCE TO RELATED APPLICATION

This application claims priority to Provisional Application No. 61/561,606 filed on Nov. 18, 2011, which is hereby incorporated by reference.

### FIELD OF THE INVENTION

The present invention generally relates to systems and methods for scheduling resources, such as over one or more networks.

### SUMMARY

In one example, a system for scheduling one or more resources is provided.

In another example, a method for scheduling one or more resources is provided.

In another example, a system for rescheduling one or more resources is provided.

In another example, a method for rescheduling one or more resources is provided.

In yet another example, a system and method are provided and adapted to provide a possible allocation schedule for one or more resources in real-time through a network, such as, for example, the internet, cellular network, etc., to one or more web or mobile platforms.

In still another example, a method and system are provided and adapted to provide a possible allocation schedule for one or more resources through a network, such as, for example, the internet, cellular network, etc., to one or more web or mobile platforms, any of which may be used to schedule the one or more resources.

In a further example, a method and system are provided and adapted to provide a possible allocation schedule for one or more resources through a network to one or more web or mobile platforms, any of which may be used by a user to schedule the one or more resource. In one aspect, the one or more resource may be scheduled for multiple users contemporaneously.

In a further example, a method and system are provided and adapted to provide a possible allocation schedule for one or more resources in real-time through a network to one or more web or mobile platforms, any of which may be used by a user to reschedule the one or more resource. In one aspect, the one or more resource may be rescheduled for multiple users contemporaneously.

In a further example, a method and system are provided and adapted to allow a user to cancel one or more resource. In one aspect, the one or more resource may be cancelled for multiple users contemporaneously.

### BRIEF DESCRIPTION OF THE DRAWINGS

FIG. 1 is a schematical diagram of an exemplary architecture of the present invention;

FIGS. 2-7 represent various exemplary features and capabilities of a scheduling system and method in accordance with the present invention;

Before any independent features and embodiments are explained in detail, it is to be understood that the present disclosure is not limited in its application to the details of the construction and the arrangement of the components set forth in the following description or illustrated in the drawings. The systems and methods described herein are capable of arrangement in other embodiments and of being practiced or carried out in various ways. Also, it is understood that the phraseology and terminology used herein is for the purpose of description and should not be regarded as limiting.

### DETAILED DESCRIPTION

The exemplary systems and methods described herein are adapted to schedule a resource through a network, such as, for example, the internet, a cellular network, etc., to one or more web or mobile platforms, any of which may be used by a user to schedule the resource. The particular embodiment described herein relates to the scheduling of lessons, specifically swim lessons. Exemplary resources described herein are instructors, class types, facilities, lanes, and class times or slots. It should be noted, however, that the present disclosure is not intended to be limited to such exemplary embodiments. The systems and methods described herein are applicable to the scheduling of resources of other types. For instance, the systems and methods could be applied to other types of lessons or instruction, e.g. golf, piano, dance, language, academic, etc. Further, the systems and methods described herein are not limited to the provision of lessons or instruction. Other applications include the scheduling or reservation of goods, services, events, spaces, and so forth are contemplated. For example, the systems and methods described herein can be used to schedule a variety of resources, such as travel reservations (e.g. air, train, hotel), business services (e.g. conference rooms), and rentals of objects and things.

The systems and methods described herein allow multiple users to schedule multiple resources contemporaneously. A common problem with scheduling relates to the difficulty in scheduling multiple individuals to utilize multiple resources at the same time or within the same time slot. For instance, a parent may desire to sign up multiple children for a lesson. Each of the children, however, may have a different level of competence and require a different level of instruction. At the same time, for convenience, the parent may want the children to each receive their particular level of instruction at the same time. That is, the parent may not want the burden of having to engage in multiple trips to transport their children to the lessons. Scheduling this way is time consuming and difficult. The methods and systems described herein allow the quick and efficient scheduling of multiple resources (i.e. lessons) for multiple users during the same time period.

It is to be appreciated the methods and systems are described below more fully with reference to the accompanying drawings, in which illustrated embodiments of the present invention are shown. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that certain embodiments of this invention as discussed below are a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

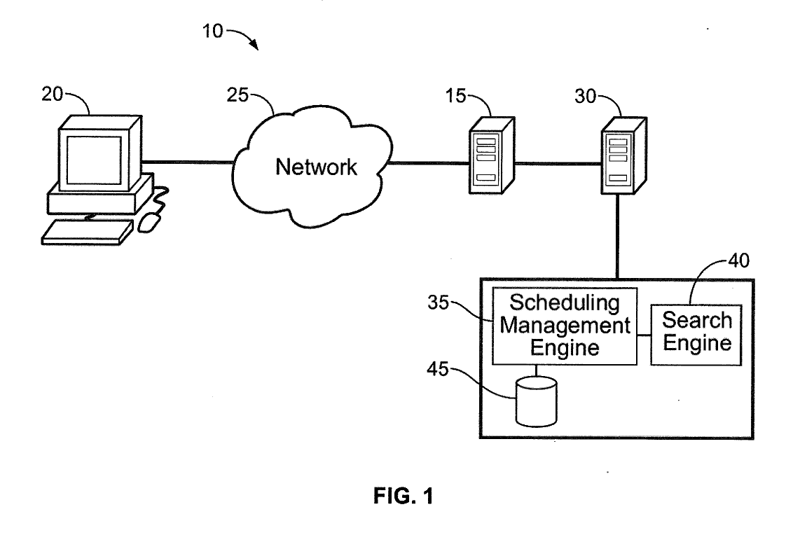

With reference to FIG. 1, an exemplary architecture is illustrated to demonstrate an exemplary technical infrastructure associated with the systems and methods of the present invention. The illustrated exemplary architecture is not intended to be limiting upon the present invention. Rather, the systems and methods are capable of having numerous other architectures, all of which are intended to be within the spirit and scope of the present invention.

Referring to FIG. 1, in one exemplary embodiment, a system (indicated generally at 10) comprises a network server 15 that is connected to a user computer 20 through a network 25. The network server 15 is also connected to an application server 30 through a LAN. A scheduling management engine 35 runs on the application server 30 and is used to receive and process scheduling requests. The scheduling management engine 35 uses a search engine 40 to process scheduling requests. In addition, the scheduling management engine 35 accesses a database 45 located on the application server 30 for storage and retrieval of resource information such as instructor information, student information, class information (e.g. class titles and available times), facility information (e.g. swim lanes and availability). Alternatively, a single server or multiple servers could be used to perform the functions of the network server 15 and/or application server 30. Exemplary hardware for the servers includes a Sun Fire X2200 M2, AMD Opteron 2x 2218DC (2.6 GHz Dual Core x64) 8 GB RAM running Centos 5 and Apache 2.2.3 w/php.

The network server 15 in one example is a dedicated web server adapted to provide a network interface between the user computer 20 and the application server 30. The network server 15 serves web pages to the user computer 20, which are displayed for the user by a web browser on the user computer 20. The network server 15 also receives input data entered by the user through the user computer 20 and transmitted to the network server 15 over the network 25. Much of the content displayed in the various web pages sent to the user computer 20 from the network server 15 is generated by the system 10 based on communications between the network server 15 and the user computer 20. However, the processing for generating the content and for carrying out instructions entered by the user is performed by the application server 30, which is transparent to the user.

Network 25 may include a local area network (LAN) and/or a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules may be stored in a remote memory storage device such as a storage medium. Devices may communicate over network 25 through one or more communications links. Communication links may be wired (e.g. Ethernet, USB, Firewire, etc.) or wireless (e.g. Bluetooth, 802.11, 3GPP, 3GPP2, etc.) or a combination thereof. Devices may also communicate with each other through other wireless technologies as (RFID, IrDA, barcodes) or use of communications applications, such as Bump™.

The application server 30 acts as an interpreter between the network environment of the network server 15 and the user computer 20, and the back end systems (such as the scheduling management engine 35, search engine 40, and database 45), which carry out the searches and the scheduling processes.

The user computer 20 receives input commands and data from a user and interacts with the network server 15 via the network 25. The network server 15 is adapted to send web pages to and receive requests and data from the user computer 20. The web pages sent to the user computer 20 by the network server 15 are displayed on the user computer 20, such as on a monitor or other display device, and form a user interface by which the user interacts with the system 10. The network server 15 receives data entered by the user and forwards the data to the application server 30. The application server 30 formulates queries based on the data entered by the user and sends the queries to the search engine 40, which searches the database 45 for resources that meet the user's requirements. When a search is complete, the search engine 40 forwards the search results to the application server 30, which generates a results page that the network server 15 sends to the user computer 20 via the network 25, where the results are displayed for the user. The user then interacts with the results page through computer 20 to schedule one or more resources.

It must be noted that the descriptions of network sever 15, user computer 20, and application server 30 are not mean to be limiting. In other embodiments the functions carried out by these devices can be consolidated into a single device. In addition, these devices may individually or collectively be replaced by any device that could provide the functionality described herein. Such devices may be coupled to another device or to peripheral devices. FIG. 1 depicts network server 15, user computer 20, and application sever 30 as standalone for illustrative purposes. However, the functions described in connection therewith could be performed by multiple devices that are coupled and function together as part of a distributed processing environment. Exemplary devices include, but are not limited to, computing devices, such as mobile devices (e.g. cell phones, smart phones, etc.), personal computers, notebook computers, tablet computers, servers, etc. Such devices would generally include at least one processor, at least one data interface, and at least one memory device coupled via buses.

A processor is an electronic device configured of logic circuitry that responds to and executes instructions. A processor may comprise more than one distinct processing devices, for example to handle different functions. A processor may output results of an execution of the methods described herein to an output device connected to an interface. Alternatively, a processor could direct the output to another device via a network.

A data interface may include the mechanical, electrical, and signaling circuitry for communicating data over a network. A data interface may be configured to transmit and/or receive data using a variety of different communication protocols and various network connections, e.g., wireless and wired/physical connections. An interface may include an input device, such as a keyboard, a touch screen or a speech recognition subsystem, which enables a user to communicate information and command selections to processor. An interface may also include an output device such as a display screen, a speaker, a printer, etc. An interface may include an input device such as a touch screen, a mouse, track-ball, or joy stick, which allows the user to manipulate the display for communicating additional information and command selections to a processor.

A memory device in one example comprises a computer-readable signal-bearing medium. One example of a computer-readable signal-bearing medium for system comprises a recordable data storage medium, such as a magnetic, electrical, optical, biological, and/or atomic data storage medium. In another example, a computer-readable signal-bearing medium comprises a modulated carrier signal transmitted over a network. In one example, a memory device includes a series of computer instructions written in or implemented with any of a number of programming languages, as will be appreciated by those skilled in the art.

A memory device in one embodiment includes database 45. Database 45 may reside in memory that is directly communicable over network 25 or it may reside in memory on network server 15, user computer 20, or application server 30 as shown in FIG. 1.

The term “engine” with reference to scheduling management engine 35 and search engine 40 denotes a functional operation that may be embodied either as a stand-alone component or as an integrated configuration of a plurality of subordinate components. Thus, scheduling management engine 35 and search engine 40, may be implemented as a single module or as a plurality of modules that operate in cooperation with one another. Moreover, scheduling management engine 35 and search engine 40, may be implemented as software instructions in memory or separately in any of hardware (e.g., electronic circuitry), firmware, software, or a combination thereof. Scheduling management engine 35 and search engine 40 contain instructions for controlling a processor to execute the methods described herein. Examples of such methods are explained below.

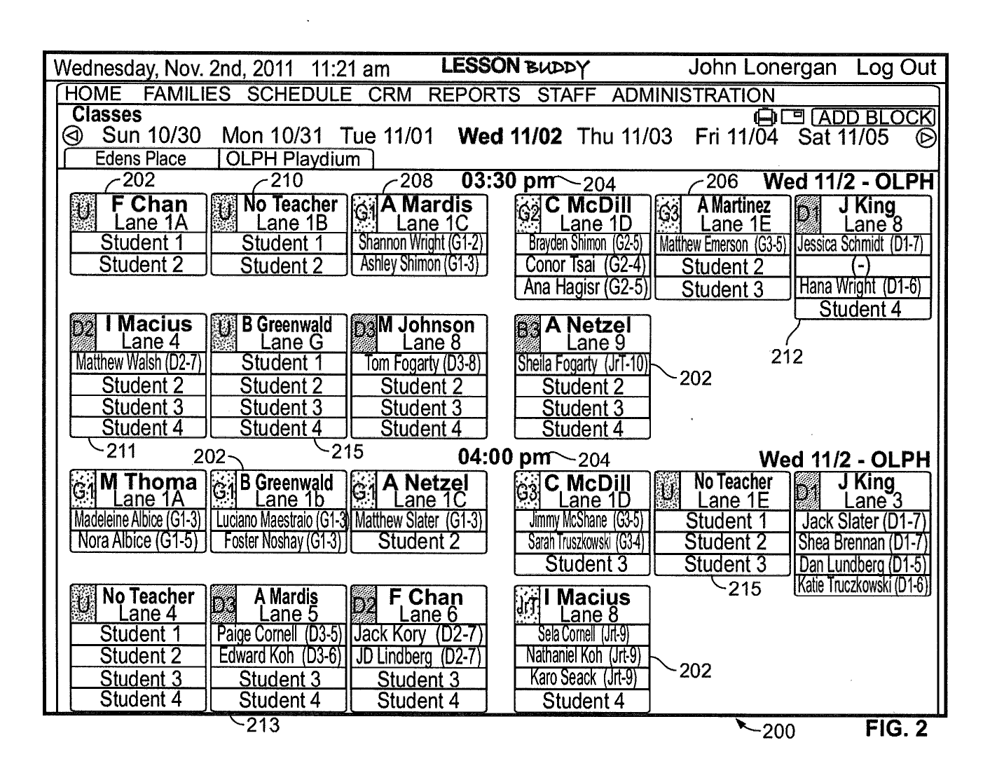

Referring to FIG. 2, a user interface screen 200 is shown that depicts a plurality of scheduling blocks 202. Each scheduling block 202 is associated with a time 204 and includes information, such as the class type 206, instructor 208, swim lane 210, and student name 212. The information populating each scheduling block 202 is stored in database 45. In one embodiment, user interface screen 200 is used by a lesson provider to assign, schedule, and track resources, such as instructors, class offerings, swim lanes, and time slots. That is, the provider populates scheduling blocks 202 with the underlying data relating to the particular class offerings. The provider can also manually schedule students for particular time slots, swim lanes, and class types through the use of scheduling blocks 202.

Referring further to FIG. 2, the time 204 is the particular time at which a class or lesson is offered. For instance, the class represented by block 211 is offered at 3:30 PM and the class represented by block 213 is offered at 4:00 PM.

Class type 206 refers to the level of instruction that is provided in the class. For instance, “G1” refers to a first level “Guppy” class; “B3” refers to a third level “Barracuda” class; D2 refers to second level “Dolphin” class. Of particular note is the designation “U”, which can be seen as the class level 206 for one or mores instances of block 215. The designation “U” refers to a “universal” block 215. Universal blocks 215 are not assigned to a particular class type 206 and are allocated as user demand requires. Hence, universal blocks 215 provide for efficient resource allocation by allowing user or customer demand to determine what classes are provided. For example, if a user were to request a Barracuda level 2 or “B2” class at 3:30 PM, the application server 30 would determine that there were no “B2” classes available at 3:30 PM. The system 10 would then search to determine whether there were any class offerings designated by a universal block 215. As can be seen, FIG. 2 depicts two universal blocks 215 at 3:30 PM. Accordingly, the system 10 would change class type 206 for one of the universal blocks 215 from “U” to “B2” and the user would be able to register a student in second level Barracuda at 3:30 PM. Database 45 would be updated and then future requests for second level Barracuda could be fulfilled in accordance with the availability reflected by scheduling blocks 202. If the user elected not to register a student as a second level Barracuda at 3:30 PM, then the block would be return designated as a universal block 215. Similarly, if all the scheduled students in a particular block 202 were to cancel, then the block 202 could be designated as a universal block 215.

As will be further discussed herein, the designation of scheduling blocks 202 by class type 206 will often be done transparently to the system users. It will be done in response to the scheduling requests made by users via their computers 20. However, the operation could also be performed through manual input by a user who works for the provider of swim lessons.

Referring further to FIG. 2, instructor 208 is the name of the instructor who teaches a class represented by a scheduling block. Swim lane 210 is the lane in which the class will be held. Student name 212 represents a student who is scheduled for the class represented by the scheduling block 202.

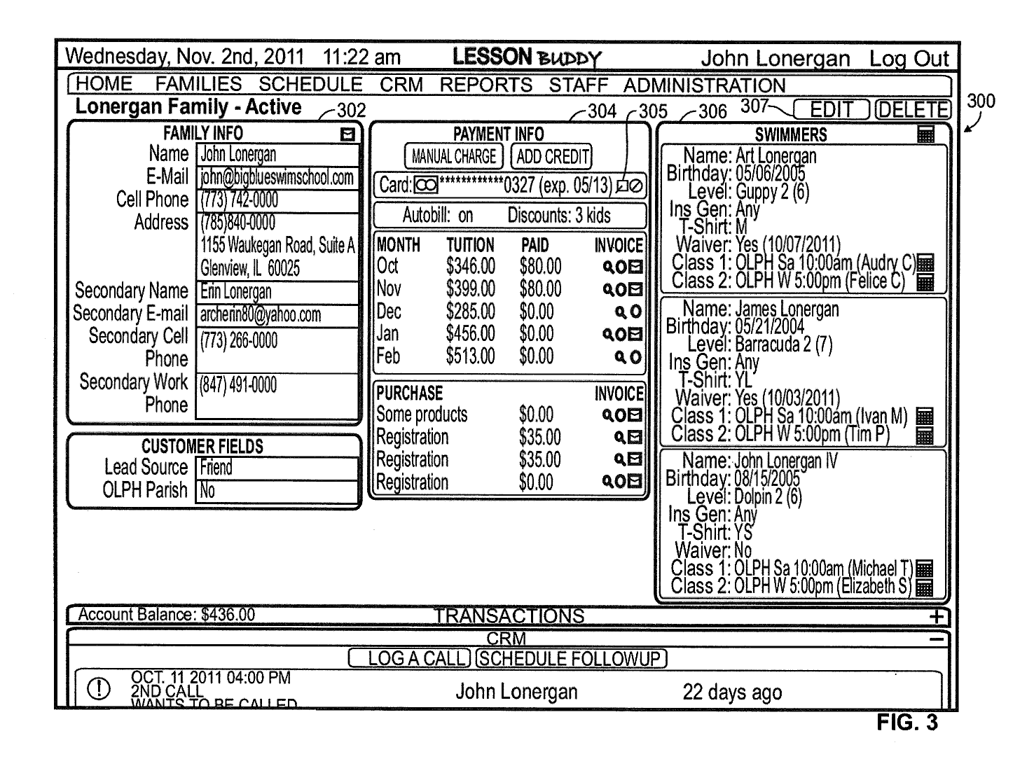

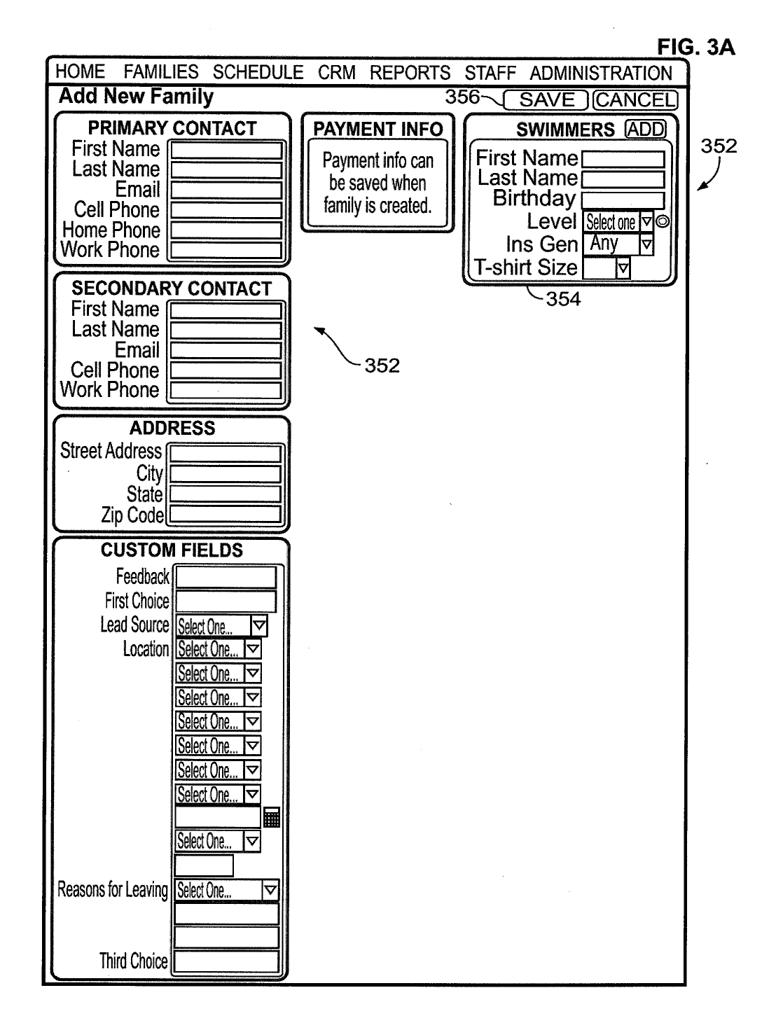

Referring to FIG. 3, an exemplary user interface screen 300 is shown by which a user sets up and adds students to an account. User interface screen 300 in one example comprises family information 302, payment information 304, and student information 306. Family information 302 is the umbrella information that designates the account holder or the person who manages the account.

Payment information 304 in one example comprises the information used by lesson provider to receive payment for lessons (e.g. credit card information) and also provides information such as account history, invoices, applicable discounts and so forth. Payment information 304 is entered by actuating button 305 and entering information into the requested fields. The information is then populated into database 45.

Student information 306 in one example comprises the names of each student registered under the account. The information is then populated into database 45. In one example, student information includes information such as name, birthday, class level (type), t shirt size, class registration, and instructor preference information.

Family information 302 and student information 306 is entered by actuating edit button 307 and entering information into the requested fields. FIG. 3A depicts an exemplary information intake screen 350 into which family information 302 and student information 306 is entered. As is depicted information intake screen 350 includes a family information intake area 352 that requests such items as primary contact, secondary contact, address, and certain custom fields. For student information 306, information intake screen 350 includes a student information intake area 354 that requests information such as name, birthday, class level (type), t shirt size, class registration, and instructor preference information. After entering information into the intake areas 352, 354, they user actuates save button 356 and the information is then populated into database 45.

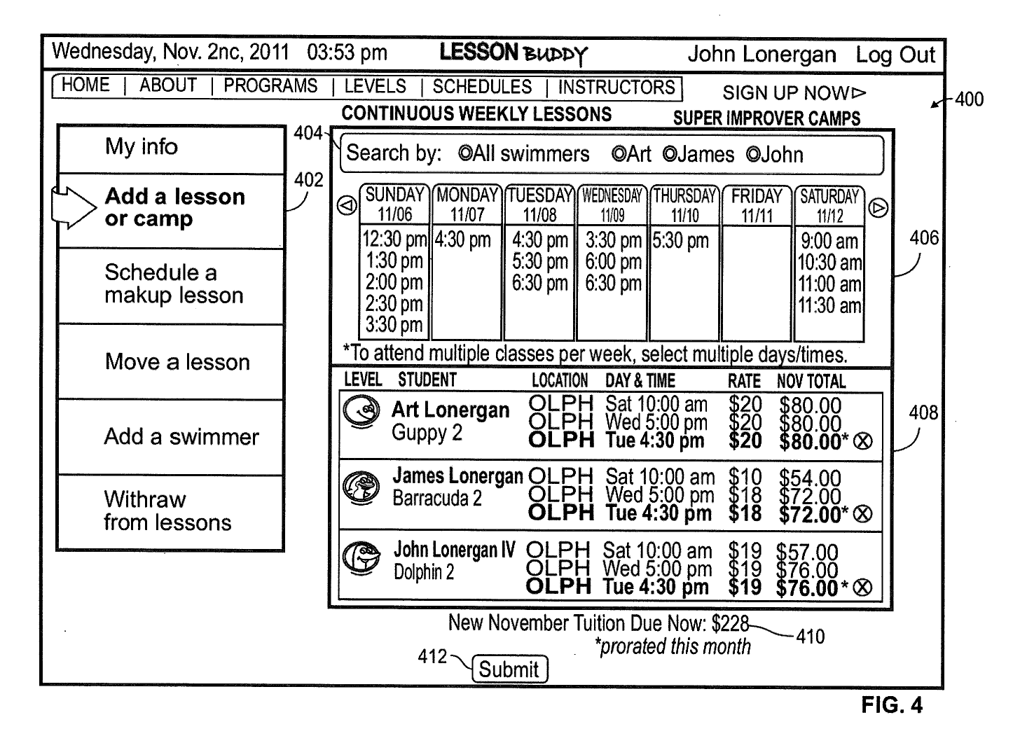

Referring to FIG. 4, an exemplary process by which a user schedules a lesson for one more students is now described for illustrative purposes. User interface screen 400 is the screen by which a user can schedule one or more classes for one more students contemporaneously. User interface screen 400 is entered by actuating control link 402. User interface screen includes a student selector 404, calendar 406, class information 408, and tuition information 410.

Student selector 404 allows a user to search for available class times simultaneously for multiple users. For example, if user wanted to search only for available classes for Art, the user would only actuate the selection button next to Art. If the user wanted to search only for James, the user would only actuate the selection button next to James. If the user wanted to search only for John, the user would only actuate the selection button next to John. If the user wanted to search for available classes for two of the three students, the user would select the selection button next to two students. If the user wanted to search for available class times for all three students simultaneously, the user would actuate the selection button next to “All Swimmers”.

Upon actuation of the selection button, user computer 20 sends the selection criteria (i.e. the particular students for whom a search is specified) through network 25 and web server 15 to application server 30. Application server 30 commences a search using search engine 40 of database 45 for classes meeting the selection criteria. For instance, referring to FIG. 3, it can be seen from student information 306, that Art is a “Guppy 2”, James is a “Barracuda 2”, and “John” is a “Dolphin 2”. The system 10 searches database 45 for times 204, or class slots, (FIG. 2) during which all of Guppy 2, Barracuda 2, and Dolphin 2 are available. In one aspect the system 10 will also search database for class slots during which all three classes are provided at the same location. If all three classes are available during a particular time, application server 30 sends the class information to user computer 20 for population in calendar 406. If more than one class slot is available then multiple class slots are shown in calendar 406.

Provided that there are class slots available in calendar 406, the user then selects the class or classes that the user would like to schedule for the selected students. This is done in one example by using a pointing device to select the applicable class times. After selection of the class times, class information display 408 is populated with information regarding the selected classes. In the example shown, Art, James, and John have been selected for inclusion in three time slots, Saturday at 10 AM, Wednesday at 5 PM, and Tuesday at 4:30 PM. The rates and tuition for each class are also shown in class information display 408. The total tuition due is shown in the tuition information display 410. If the user is satisfied with the selections, the user will actuate the submit button 412 and the application server 30 will complete the reservation and the database 45 will be updated. If the lesson provider were to navigate to user interface screen 200, the scheduling blocks 202 would reflect the scheduling of Art, James, and John. Swimming information 306 on interface screen 300 is similarly updated to reflect these changes

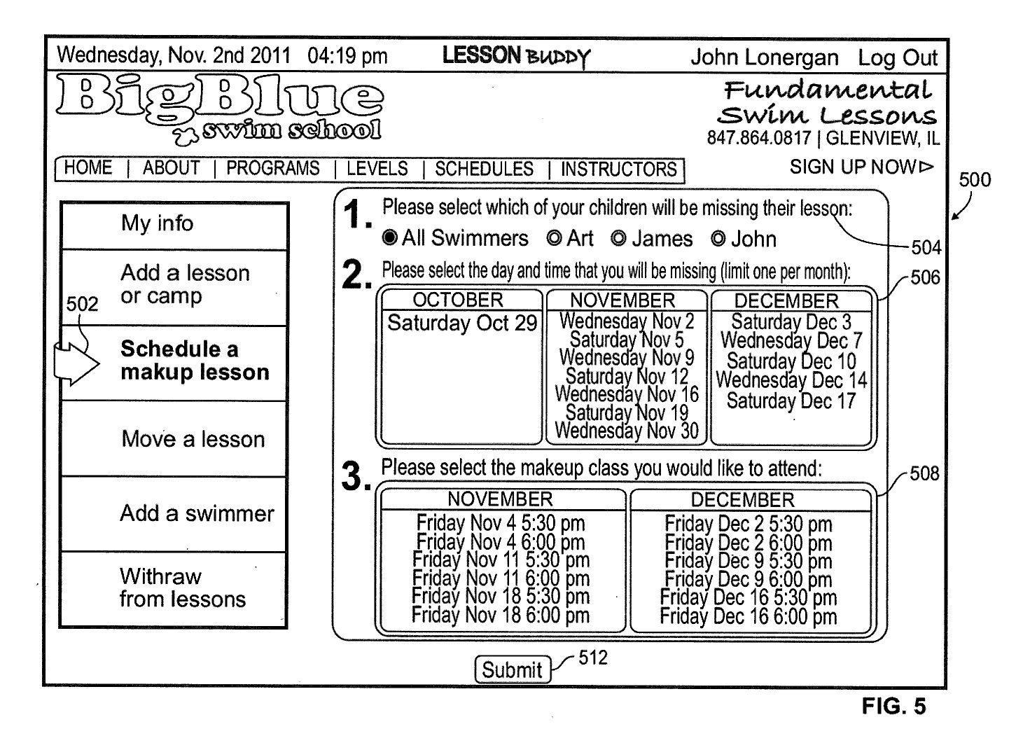

Referring to FIG. 5, an exemplary description of a process by which a user can schedule a make-up session for one or more students will now be described for illustrative purposes.

Make-up selection interface screen 500 is entered by actuating control link 502. Make-up selection screen includes student selector 504, missing class selector 506, and make up class selector 508.

Student selector 504 allows a user to search for available class times simultaneously for multiple users. For example, if user wanted to search only for make-up classes for Art, the user would only actuate the selection button next to Art. If the user wanted to search only for James, the user would only actuate the selection button next to James. If the user wanted to search only for John, the user would only actuate the selection button next to John. If the user wanted to search for make up classes for two of the three students, the user would select the radio button next to the two students in question. If the user wanted to search for make-up class times for all three students simultaneously, the user would actuate the selection button next to “All Swimmers”.

Upon actuation of the selection button, user computer 20 sends the selection criteria (i.e. the particular students for whom a search is specified) through network 25 and web server 15 to application server 30. Application server 30 commences a search using search engine 40 of database 45 for classes meeting the selection criteria. For instance, because Art is a “Guppy 2”, James is a “Barracuda 2”, and “John” is a “Dolphin 2”. The system 10 searches database 45 for times 204, or class slots, (FIG. 2) during which Guppy 2, Barracuda 2, and Dolphin 2 are available. In one aspect the system 10 will also search database for class slots during which all three classes are provided at the same location. If all three classes are available during a particular time, application server 30 sends the class information to user computer 20 for population in make up class selector 508. If more than one class slot is available then multiple class slots are shown in make up class selector 508.

Missing class selector 506 is populated with the upcoming class times for the student or students for whom a make-up is sought. The user can then select the class time for which a make-up is sought from missing class selector 506 and select the class time from make-up class selector 508 which the user would like to use as the make-up. The users then actuates the submit button 510 and the application server 30 will complete the make-up request and database 45 will be updated. If the lesson provider were to navigate to user interface screen 200, the scheduling blocks 202 would be updated to reflect the rescheduling of Art, James, and John. Swimming information 306 on interface screen 300 is similarly updated to reflect these changes

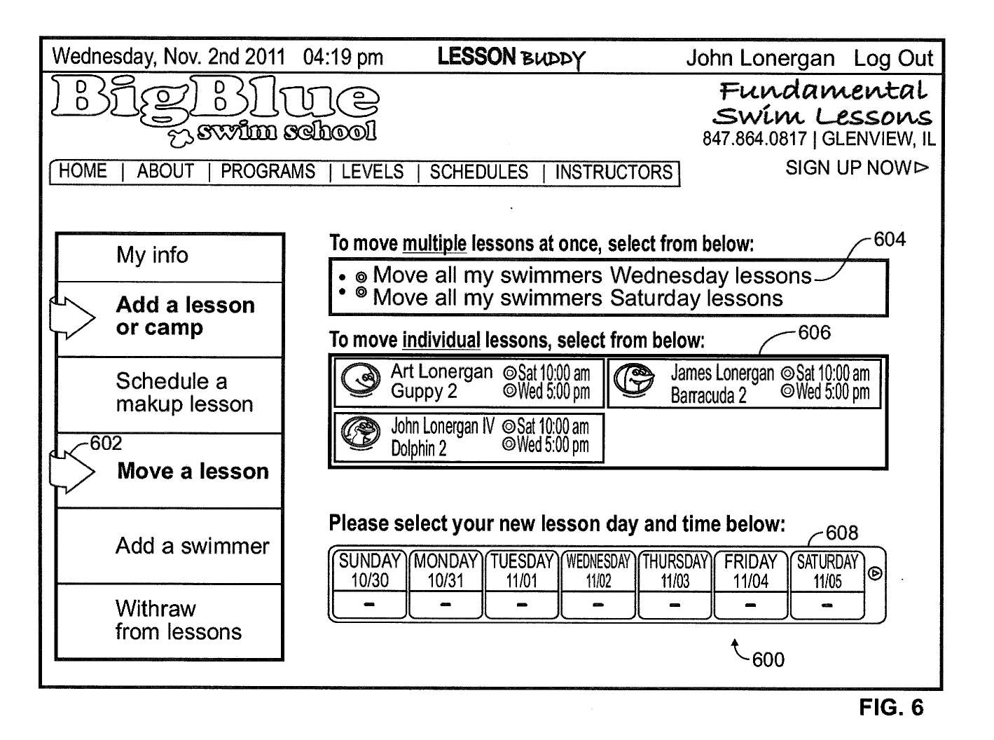

Referring to FIG. 6, an exemplary process by which a user can move all lessons for one or more students is now described for exemplary purposes. Move lesson interface screen 600 is entered by actuating control link 602. Move lesson interface 600 includes an all student selector 604, an individual student selector 606, and calendar 608.

Student selector 604 allows a user to search and move class times simultaneously for multiple users. For example, If a user wanted to search for available class times and move classes for all three students simultaneously, user would actuate, depending on the particular class day that the user wanted to move, one or both of the selection button in the all student selector 604. If user wanted to search and move only for Art, the user would only actuate one or both of the selection buttons next to Art in the individual student selector 606. If the user wanted to search and move only for James, the user would only actuate one both of the selection buttons next to James in the individual student selector. If the user wanted to search and move only for John, the user would only actuate one or both of the selection buttons next to John in the individual student selector 606. If the user wanted to search for available classes for two of the three students, the user would select one or more selection buttons for each of the two students in question.

Upon actuation of the selection button(s), user computer 20 sends the selection criteria (i.e. the particular students for whom a search is specified) through network 25 and web server 15 to application server 30. Application server 30 commences a search using search engine 40 of database 45 for classes meeting the selection criteria. Because Art is a “Guppy 2”, James is a “Barracuda 2”, and “John” is a “Dolphin 2”, the system 10 searches database 45 for class slots, for which Art, John, and James are not already scheduled, during which Guppy 2, Barracuda 2, and Dolphin 2 are all available. In one aspect the system 10 will also search database 45 for class slots during which all three classes are provided at the same location. If all three classes are available during a particular time, application server 30 sends the class information user computer 20 for population in calendar 608. If more than one class slot is available then multiple class slots are shown in calendar 608.

Provided that there are class slots available in calendar 608, the user can then select the time slot to which the user would like to move the selected students. This is done in one example by using a pointing device to select the applicable class times. After selection of the class times, the application server 30 and the database 45 will be updated to reflect the move. If the lesson provider were to navigate to user interface screen 200, the scheduling blocks 202 would be updated to reflect the move. Swimming information 306 on interface screen 300 is similarly updated to reflect these changes

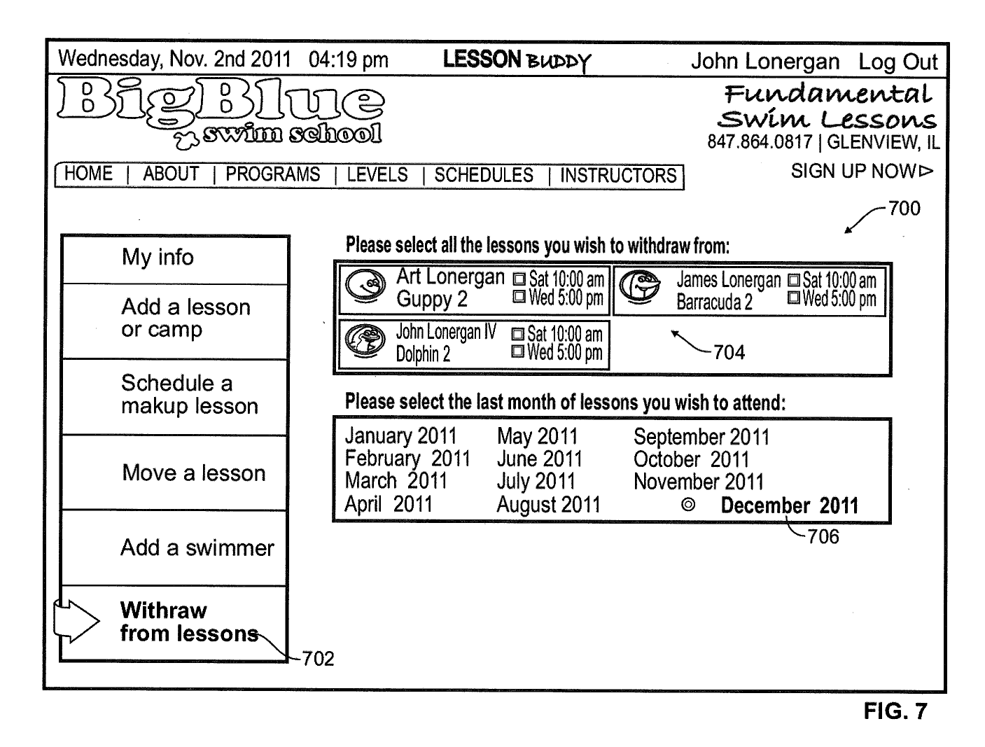

Referring to FIG. 7, an exemplary process by which a user can cancel or withdraw one or more students will now be provided for illustrative purposes.

Lesson withdraw interface screen 700 is entered by actuating control link 702. Upon entry into withdraw interface screen 700 application server 30 sends data to user computer 20 to populate student selector 704 and last lesson selector 706.

Student selector 704 allows a user to cancel lessons for one, two or all of the students. For example, if a user wanted to cancel lessons for all of the students, the user would actuate, depending on the particular class day that the user wanted to cancel, one or both of the selection buttons for each of the students. If user wanted to cancel one or both of Art's lessons, the user would only actuate one or both of the selection buttons next to Art in the student selector 704. The user would use the same process to cancel lessons for James and/or John.

Last lesson selector 706 allows the user to select the last month for which the selected student wants to attend lesson. After selection of the class times, the application server 30 and the database 45 will be updated to reflect the cancellation. If the lesson provider were to navigate to user interface screen 200, the scheduling blocks 202 would be updated to reflect the cancellation, including the conversion of scheduling blocks 202 to universal blocks 215 to the extent that all students for a given scheduling block were cancelled. Swimming information 306 on interface screen 300 is similarly updated to reflect these changes

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

1. A computer implemented method, comprising:
receiving a scheduling request from a requesting device, wherein the scheduling request comprises a request to reserve a first resource for a first entity and a second resource for a second entity;
searching a database to identify at least one schedule slot during which the first resource can be reserved for the first entity and the second resource can be reserved for the second entity; and
sending at least one scheduling slot to the requesting device.

2. The computer implemented method of claim 1, wherein the step of receiving comprises receiving a request for the first entity to be scheduled for a first type of lesson and a second entity to be scheduled for a second type of lesson.

3. The computer implemented method of claim 2, wherein the first type of lesson and the second type of lesson relate to the same skill.

4. The computer implemented method of claim 3, wherein the first type of lesson and the second type of lesson relate to a different degree of proficiency at the same skill.

5. The computer implemented method of claim 1, wherein the schedule slot includes a date on which the first resource and the second resource can be fulfilled for both the first entity and the second entity, respectively.

6. The computer implemented method of claim 5, wherein the schedule slot includes a time of day at which the first resource and the second resource can be fulfilled for both the first entity and the second entity, respectively.

7. The computer implemented method of claim 1, further comprising:
receiving at least one schedule slot at the receiving device;
displaying the at least one schedule slot on the receiving device.

8. The computer implemented method of claim 7, wherein the at least one schedule slot comprises a plurality of schedule slots, and the step of displaying comprises organizing the plurality of schedule slots by date and time.

9. The computer implemented method of claim 1, wherein the step of searching comprises:
searching the database to identify a plurality of schedule slots which allow fulfillment of scheduling the first resource for the first entity; and
searching the plurality of schedule slots to identify at least on schedule slot that allows fulfillment of scheduling of the second resource for the second entity.

10. The computer implemented method of claim 1, wherein the first resource and the second resource are one of a good, a service, an events, a space, and a lesson.

11. A computer implemented method for scheduling a plurality of resource types comprising:
providing a plurality of schedule blocks, wherein at least one of the schedule blocks is designated as corresponding to one of the plurality of resource types;
selecting at least one of the schedule blocks to be a universal block that is not designated as corresponding to one of the plurality of resource types;
receiving a request to reserve a resource;
determining whether or not one of the plurality of schedule blocks is designated as corresponding to a resource type of the resource;
if one of the schedule blocks is designated as corresponding to the resource, then utilizing the schedule block to reserve the resource; and
if one of the schedule blocks is not designated as corresponding to the resource, then utilizing the universal block to reserve the resource.

12. The method of claim 11, wherein the step of utilizing the universal block to reserve the resource comprises changing the universal block to being designated as corresponding to the resource type of the resource.

13. The method of claim 12, further comprising:
receiving a request to cancel reservation of the resource;
cancelling reservation of the resource; and
re-designating the block corresponding to the resource type of the resource to a universal block.

14. A computer implemented method for rescheduling reservations for multiple entities, the method comprising:
receiving a rescheduling request from a requesting device, wherein the rescheduling request comprises a request to reschedule a first resource for a first entity and a second resource for a second entity;
searching a database to identify at least one reschedule slot during which the first resource can be reserved for the first entity and the second resource can be reserved for the second entity, wherein the at least one reschedule slot is not currently reserved by either the first entity or the second entity; and
sending the at least one reschedule slot to the requesting device.

15. The computer implemented method of claim 14, wherein the reschedule slot includes a date on which the first resource and the second resource can be fulfilled for both the first entity and the second entity, respectively.

16. The computer implemented method of claim 15, wherein the reschedule slot includes a time of day at which the first resource and the second resource can be fulfilled for both the first entity and the second entity, respectively.

17. The computer implemented method of claim 1, further comprising:
receiving the at least one reschedule slot at the receiving device;
displaying the at least one reschedule slot on the receiving device.

18. The computer implemented method of claim 17, wherein the at least one reschedule slot comprises a plurality of reschedule slots, and the step of displaying comprises organizing the plurality of reschedule slots by date and time.

19. The computer implemented method of claim 14, wherein the step of searching comprises:
searching the database to identify a plurality of reschedule slots which allow fulfillment of rescheduling the first resource for the first entity; and
searching the plurality of reschedule slots to identify at least one reschedule slot that allows fulfillment of rescheduling of the second resource for the second entity.

20. The computer implemented method of claim 14, wherein the first resource and the second resource are one of a good, a service, an events, a space, and a lesson.
